(19) United States
(12) Patent Application Publication
(10) Pub. No.: US 2008/0091494 A1
(43) Pub. Date: Apr. 17, 2008

(54) Application for after-hours event notifications

(75) Inventors: Melissa Betancourt, Miami, FL (US); Rodrigo J. Pastrana, Delray Beach, FL (US)

Correspondence Address: CANTOR COLBURN LLP - IBM BOCA RATON, 20 Church Street, 22nd Floor, Hartford, CT, 06103, US

(73) Assignee: INTERNATIONAL BUSINESS MACHINES CORPORATION, Armonk, NY (US)

(21) Appl. No.: 11/549,202

(22) Filed: Oct. 13, 2006

(51) Int. Cl. G05B 19/418

(52) U.S. Cl. 705/8

(57) ABSTRACT

Disclosed herein too is a method for notifying a user of an early event prior to a first time t₁ comprising selecting from a first command interface 20 of an implementation screen 10 an event that the user desires notification of; selecting from a second command interface 30 of the implementation screen 10 a first time t₁, prior to which the user desires notification of all events that occur before t₁; a final time tₙ, prior to t₁, that the user would like to be notified of all those events occurring before t1; and a period t₂ in minutes, hours, days or weeks prior to t₁ that notification is desired; and specifying from a third command interface 40 of the implementation screen 10, a time T₁ in minutes prior to the final time tₙ, that the user desires notification of corresponding events of interface 20.

### TRADEMARKS

IBM® is a registered trademark of International Business Machines Corporation, Armonk, N.Y., U.S.A. Other names used herein may be registered trademarks, trademarks or product names of International Business Machines Corporation or other companies.

### BACKGROUND

1. Field of the Invention

This disclosure relates to after hours event notifications.

2. Description of Related Art

Notifications for meetings or appointments (hereinafter “events”) are frequently automatically received from applications such as Microsoft OUTLOOK® or Lotus NOTES®. Users who require notifications generally program the respective application to remind them of the event. The user specifies a period of time prior to the starting of the event at which time the application will remind the user of the occurrence of the event. For example, the user may program the application to remind him or her of a 9:00 AM event at least 30 minutes prior to the start of the event. The application can also be programmed to repeatedly and successively remind the user of the event at different times prior to the start of the event.

An example of this application is shown in the FIG. 1. The implementation screen comprises a number of boxes that permit the user to specify the amount of time prior to a particular event that the computer will activate a notification. As may be seen in the FIG. 1, the user specifies that he/she would like to be reminded of the event 30 minutes prior to the event.

While this mode of reminding the user is generally useful during those hours of the day when the user is present at his/her computer terminal (which typically occurs when the user is at work), it does not remind the user of events whose specified reminders occur before or after working hours, when he/she is away from work and hence away from the computer terminal. An example of this problem generally occurs when the user has an early morning meeting (prior to 8 AM) or a late evening meeting (after 5 PM), and forgets about the meeting or arrives late because the user has received late notification or no notification from the application. The user may also need to be reminded of events ahead of time in order to prepare for the meeting and current reminders may not give them a sufficient amount of time required for preparation.

With regard to successive repeated notifications, some applications provide the user with a general option via a preferences page to notify the user of an even either a few minutes or several days in advance. This however can be confusing and the user may desire not to be reminded of all events the day before.

Some applications, such as “024h Lucky Reminder” depicted in FIG. 2, allow the user to specify the exact days, hours, and minutes of the notification for that specific event every time they create or edit an event. It can however, be tedious to go through each event manually and specify exactly how many days, hours, minutes in advance the user desires to be reminded of the event. For example, if they want to be reminded of “early” activities at 5:00 PM of the afternoon before the event, they would have to calculate how many hours and minutes they would have to specify to get the desired result of 5:00 PM.

It is therefore generally desirable to have an application that will remind the user of only those events that are scheduled to occur after hours, especially those early events that may be missed if the user does not get to work earlier than usual.

### SUMMARY

Disclosed herein is an implementation screen 10 for notifying the user of an upcoming event comprising a first command interface 20 that permits the user to turn on or off the upcoming events on the implementation screen 10; a second command interface 30 comprising a first box 32, a second box 34, a third box 36 and a fourth box 38, wherein the first box 32 permits the user to specify a first time t₁ prior to which the user would like to be notified of all events occurring before the first time t₁; the second box 34 specifies a final time tₙ prior to t₁ that the user would like to be notified of all events; the third box 36 permits the user to specify a period t₂ prior to t₁ that notification is desired and the fourth box 38 permits the user to specify the units for t₂ in minutes, hours, days or weeks prior to the event that notification is desired; and a third command interface 30 comprising a plurality of boxes, wherein at least one box permits the user to specify a first time T₁ in minutes prior to the final time tₙ that the user desires notification; and wherein the implementation screen is part of a global preference.

Disclosed herein too is a method for notifying a user of an early event prior to a first time t₁ comprising selecting from a first command interface 20 of an implementation screen 10 an event that the user desires notification of; selecting from a second command interface 30 of the implementation screen 10 a first time t₁, prior to which the user desires notification of all events that occur before t₁; a final time tₙ, prior to t₁, that the user would like to be notified of all events; and a period t₂ in minutes, hours, days or weeks prior to t₁ that notification is desired; and specifying from a third command interface 40 of the implementation screen 10, a time T₁ in minutes prior to the final time tₙ, that the user desires notification.

### TECHNICAL EFFECTS

As a result of the summarized invention, technically we have achieved a solution wherein as a result of an implementation screen, a user will be able to be notified of early events (e.g., meetings prior to 9:00 AM) a day in advance of the event. These notifications will have the capability of informing the user of the event at the end of the previous work day (e.g., after 5:00 PM). The user can specify the exact time at which they want to be notified of these early meetings (instead of calculating exact hours and minutes in advance). The feature can coexist with the current notification features provided by current programs.

### BRIEF DESCRIPTION OF THE DRAWINGS

The subject matter, which is regarded as the invention, is particularly pointed out and distinctly claimed in the claims at the conclusion of the specification. The foregoing and other objects, features, and advantages of the invention are apparent from the following detailed description taken in conjunction with the accompanying drawings in which:

FIG. 1 depicts an implementation screen wherein the user specifies that he/she would like to be reminded of the event at a certain interval prior to the event;

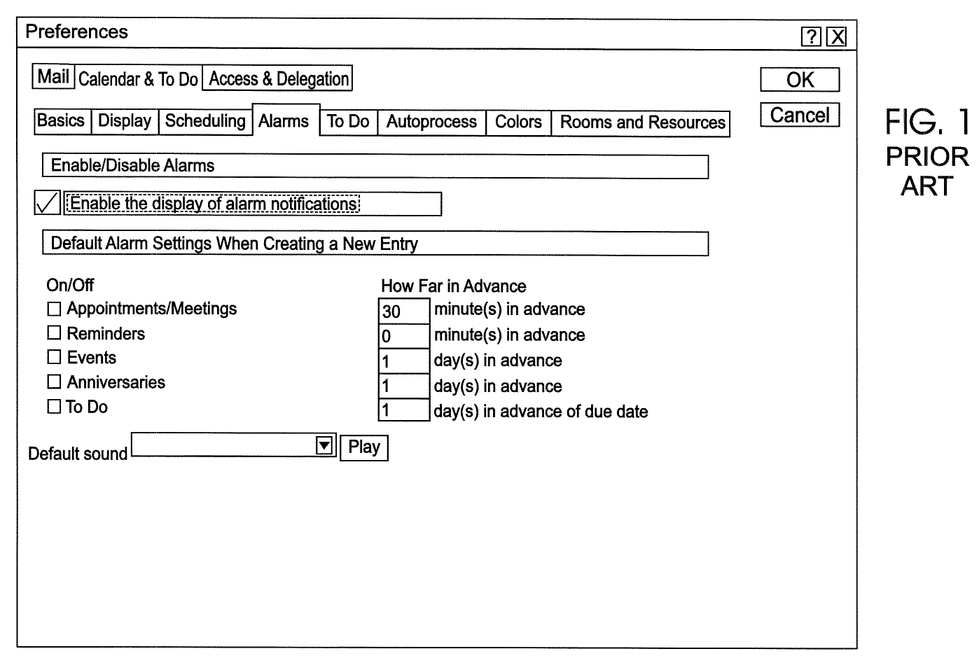

FIG. 2 is a depiction of an implementation screen of “024h Lucky Reminder”, wherein the user has to personally calculate the time in days, hours and minutes prior to the event that he/she would like to be reminded to the event; and

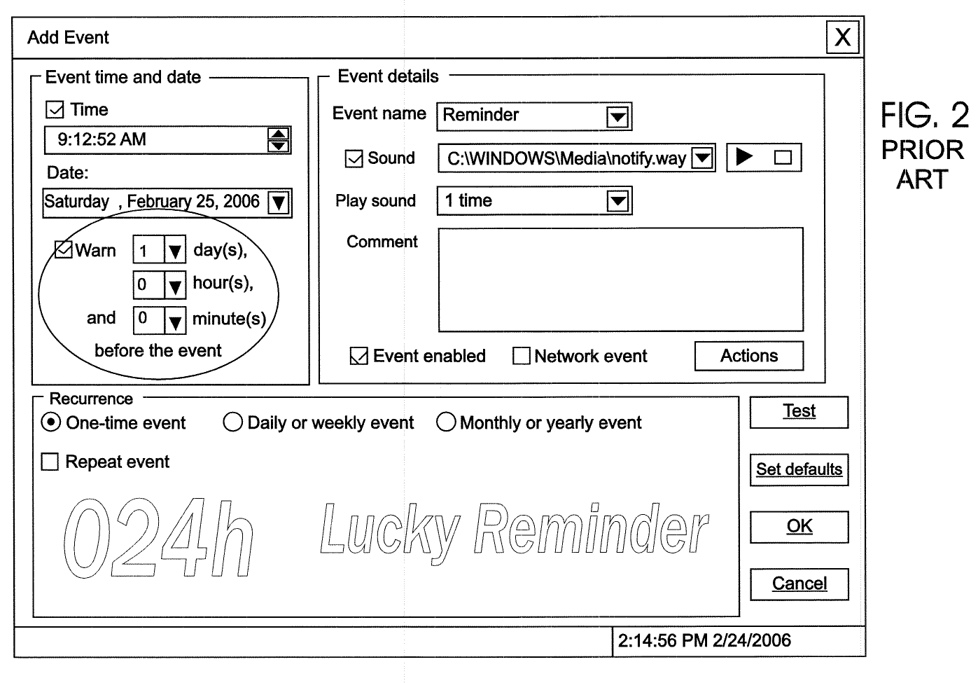

FIG. 3 is a depiction of an exemplary implementation screen that can be added to a global preference wherein the user can choose to be alerted of events that start before a certain time. As can be seen in the implementation screen, the user can choose to be alerted the day before the desired event, preferably around the time they leave work.

### DETAILED DESCRIPTION

Disclosed herein is an application that permits the user to be alerted of events that are scheduled for after-hours, early morning work-hours and during or immediately after lunch-hours on a global preference basis. In an exemplary embodiment, the application permits the user to be alerted of after-hour events, early morning work-hour events and during or immediately after lunch-hour events within a desired selected interval on a chosen day. For after-hour and early morning work-hour events, the chosen day is preferably at least one day prior to the desired event that the user desires to be reminded of. For events that are around lunch-hour, the chosen day is preferably on the same day as the desired event. In another exemplary embodiment, the application permits the user to specify the exact time that he/she would like to be notified of the event. This feature can advantageously co-exist with other current notification features provided by current programs and can be added to a global preference page.

After-hours refers to those hours in a day that the employee is not within the confines of the office. Work-hours refers to those hours when the employee would normally be within the confines of the office. Lunch hours are those hours between work-hours when the employee is not within the confines of the office. The term “global preference” indicates that the user will be notified of all meetings that are scheduled to occur prior to the chosen time, irrespective of the date or the nature of the meeting.

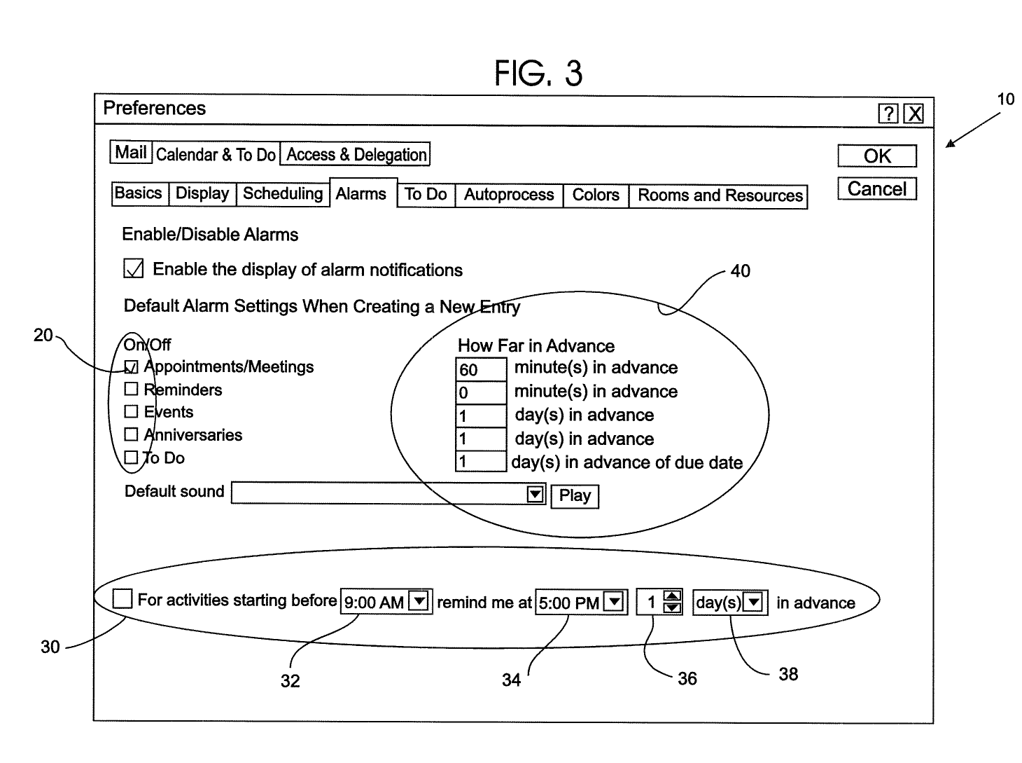

As may be seen below in the FIG. 3, an implementation screen 10 for notifying the user of an upcoming event comprises a first command interface 20 (encircled), a second command interface 30 (also encircled) and a third command interface 40 (also encircled).

The first command interface 20 and the third command interface 40 both comprise a plurality of boxes. The first command interface 20 permits the user to turn on or off the events on the implementation screen 10. As noted above, the first command interface 20 comprises a number of boxes that permit the user to select the type of event that he or she desires to be notified of. Examples of such events are appointments, meetings, anniversaries, birthdays, or the like. Thus as seen in the FIG. 3, the first command interface 20 has boxes (in order from top to bottom) that notify the user of appointments/meetings, reminders, events, anniversaries and “to do” items respectively.

The boxes in the third command interface 40 that correspond to the boxes in the first command interface 20 permit the user to specify the amount of time T₁ prior to a final time tₙ (usually the start time of the event) that they would like to be notified of the corresponding event. The third command interface 40 permits the user to select how far in advance of the final time tₙ, the computer would execute a command to activate a notification for the benefit of the user. As discussed below, the selections/specifications in the boxes in the third command interface 40 operate in conjunction with the selections/specifications in the boxes in the second command interface 30 to activate a notification.

The second command interface 30 comprises a plurality of boxes for specifying those events that a user would like to be notified of on a global preference basis. In an exemplary embodiment, the second command interface 30 comprises a first box 32, a second box 34, a third box 36 and a fourth box 38. The first box 32 permits the user to specify a first time t₁ prior to which the user would like to be notified of all events occurring before the first time t₁, while the second box 34 specifies a final time tₙ prior to t₁ that the user would like to be notified of all events. The third box 36 permits the user to specify a period t₂ prior to t₁ that notification is desired. The fourth box 38 permits the user to specify the units for t₂ in minutes, hours, days or weeks prior to the event that notification is desired. The time period t₂ can therefore vary from 0 minutes to as many weeks ahead of the event that the user desires notification of.

In one embodiment pertaining to after-hour events and early morning work-hour events, the final time tₙ represents the time at the close of a work day preceding the day of the event that the user desires notification of. With reference to the first command interface 20 in the FIG. 3, the user therefore desires to be notified of all appointments/meetings. The second command interface 30 of FIG. 3 shows that the user desires to be notified of all appointments/meeting occurring before 9:00 AM. Thus t₁ is equal to 9:00 AM. The final time tₙ by which the user desires notification is 5:00 PM. The time t₂ is selected to be “1” from the pull down box 36, while the unit is specified in days. Thus, in summary, the information provided by the user in the second command interface 30 indicates that the user desires to be notified of all events occurring prior to 9:00 AM on any given day at 5:00 PM at least one day prior to the day of the event. However, the box in the third command interface 40 specifies that the user desires to be notified at least 60 minutes prior to the final time tₙ of the appointment/meeting. Thus the implementation screen of FIG. 3 shows that the user desires to be notified of all meetings prior to 9:00 AM on any given day at least 60 minutes prior to 5:00 PM one day prior to the day of the event.

In another embodiment pertaining to lunch-time events, the final time tₙ can be used to represent the time just prior to the user's lunch break (e.g., 12:00 PM). Thus, in general, tₙ can vary from 1 minute to 24 hours, while t₂ can therefore vary from 0 minutes to several weeks ahead of the event that the user desires notification of

In one embodiment, a system can comprise one or more implementation screens that permit the user to choose this global preference type of notification for several events that occur during the course of a day. In other words, each implementation screen permits a user to choose a global preference for a different event that occurs during the course of a day. Thus there can be 1 to 10 implementation screens that permit the user to be notified on a global preference basis of 1 to 10 events.

In another embodiment, the implementation screen 10 can comprise a plurality of second command interfaces 20 that permit the user to choose this global preference type of notification for several events that occur during the course of a day. Thus there can be 1 to 10 second command interfaces that permit the user to be notified on a global preference basis of 1 to 10 events.

The implementation screen 10 further comprises a box that permits the user to select different sounds for purposes of notifying the user. Additionally it can further comprise a box that permits the enabling of the display of alarm notifications.

As can be seen in the FIG. 3, the implementation screen 10 permits a notification at any time in advance of the event. In an exemplary embodiment, the user can choose to be alerted of events that start before a certain time. As can be seen in the implementation screen, the user can choose to be alerted the day before the desired event, preferably around the time they leave work. For example in the FIG. 3, for an event occurring early in the morning at 9:00 AM, the user can request an early notification the previous day at 5:00 PM.

In one embodiment, in one method of using the implementation screen 10, a user may select or specify from the first command interface 20, which event the user desires to be notified of. The user may then select or specify from the second command interface 30 of an implementation screen 10, the first time t₁, prior to which the user desires notification of all events that occur before t₁. The user may also then select or specify from the second command interface 30 of the implementation screen 10, a final time tₙ, prior to t₁, that the user would like to be notified of all events. The user can also specify a period t₂ prior to t₁ that notification is desired while also specifying the units for t₂ in minutes, hours, days or weeks prior to the event that notification is desired. The user may also specify or select in the third command interface 40 of the implementation screen 10, a time T₁ in minutes prior to the final time tₙ, that the user desires notification.

This implementation screen has a number of advantages. As noted above, the application can be added to a global preference page and can be executed by an operating device such as a computer or a palm pad. This feature can also advantageously co-exist with other current notification features provided by current programs. In addition, the user can specify the exact time at which they want to be notified of these early meeting instead of calculating the exact hours and minutes in advance. The user will only be notified of early meetings or lunch-time meetings that there is a propensity for employees to forget. This idea can also be augmented to incorporate notifications for Monday meetings. In other words, the “day before” can be defined to mean the “previous work day”.

It is to be noted that while the terms specify or select are used above, they can be used interchangeably. Selecting applies when a pull down menu is available from which the user selects a time or a date, while specifying occurs when a pull down menu is not available on the implementation screen and the user therefore manually specifies the time or date of the event and other related information.

While the invention has been described with reference to exemplary embodiments, it will be understood by those skilled in the art that various changes may be made and equivalents may be substituted for elements thereof without departing from the scope of the invention. In addition, many modifications may be made to adapt a particular situation or material to the teachings of the invention without departing from the essential scope thereof. Therefore, it is intended that the invention not be limited to the particular embodiment disclosed as the best mode contemplated for carrying out this invention.

What is claimed is:

1. An implementation screen 10 for notifying the user of an upcoming event comprising:
a first command interface 20 that permits the user to turn on or off the upcoming events on the implementation screen 10;
a second command interface 30 comprising a first box 32, a second box 34, a third box 36 and a fourth box 38, wherein the first box 32 permits the user to specify a first time t₁ prior to which the user would like to be notified of all events occurring before the first time t₁; the second box 34 specifies a final time tₙ prior to t₁ that the user would like to be notified of all those events occurring before t₁; the third box 36 permits the user to specify a period t₂ prior to t₁ that notification is desired and the fourth box 38 permits the user to specify the units for t₂ in minutes, hours, days or weeks prior to the event that notification is desired; and
a third command interface 40 comprising a plurality of boxes, wherein at least one box permits the user to specify a first time T₁ in minutes prior to the final time tₙ that the user desires notification; and wherein the implementation screen is part of a global preference.

2. The implementation screen 10 of claim 1, wherein the implementation screen co-exists with other notification features.

3. The implementation screen 10 of claim 1, wherein the first command interface 20 comprises a plurality of boxes, each of which specifies an event.

4. The implementation screen 10 of claim 3, wherein the event is a meeting, an appointment, an anniversary or a birthday.

5. The implementation screen 10 of claim 1, wherein a box in the first command interface 20 that specifies an event has a corresponding box in the third command interface 40 that permits the user to specify the first time T₁ in minutes prior to the final time tₙ that the user desires notification

6. The implementation screen 10 of claim 1, further comprising a box that permits the user to select different sounds for purposes of notifying the user of all events.

7. The implementation screen 10 of claim 1, further comprising a box that permits the enabling of the display of alarm notifications.

8. The implementation screen 10 of claim 1, further comprising a plurality of second command interfaces 20 that permit a user to choose a global preference notification for several events that occur during a day.

9. A system comprising the implementation screen 10 of claim 1.

10. The system of claim 9, further comprising a plurality of implementation screens, wherein each implementation screen permits a user to choose a global preference for a different event that occurs during a day.

11. A method for notifying a user of an early event prior to a first time t₁ comprising:
selecting from a first command interface 20 of an implementation screen 10 an event that the user desires notification of;
selecting from a second command interface 30 of the implementation screen 10:
a first time t₁, prior to which the user desires notification of all events that occur before t₁;
a final time tₙ, prior to t₁, that the user would like to be notified of all events; and
a period t₂ in minutes, hours, days or weeks prior to t₁ that notification is desired; and
specifying from a third command interface 40 of the implementation screen 10, a time T₁ in minutes prior to the final time tₙ, that the user desires notification.
